(19) United States
(12) Patent Application Publication
(10) Pub. No.: US 2010/0074810 A1
(43) Pub. Date: Mar. 25, 2010

(54) Plasma generating system having tunable plasma nozzle

(76) Inventor: Sang Hun Lee, San Ramon, CA (US)

Correspondence Address: JORDAN AND HAMBURG LLP, 122 EAST 42ND STREET, SUITE 4000, NEW YORK, NY, 10168, US

(21) Appl. No.: 12/291,646

(22) Filed: Nov. 12, 2008

Related U.S. Application Data
(63) Continuation-in-part of application No. 12/284,570, filed on Sep. 23, 2008.

(51) Int. Cl. B01J 19/08

(52) U.S. Cl. 422/186.29; 422/186.04

(57) ABSTRACT

The present invention provides a plasma generating system that includes at least one nozzle. The nozzle includes: a housing having a cavity formed therein, where the cavity forms a gas flow passageway; a rod-shaped conductor disposed in the cavity and operative to transmit microwave energy along the surface thereof so that the microwave energy excites gas flowing through the cavity; and means for moving a proximal end of the rod-shaped conductor relative to a downstream end of the gas flow passageway.

### CROSS REFERENCE TO RELATED APPLICATIONS

This application is a continuation-in-part of application Ser. No. 12/284,570, filed on Sep. 23, 2008 entitled “Plasma generating system,” and hereby incorporates by reference said application.

### BACKGROUND OF THE INVENTION

1. Field of the Invention

The present invention relates to plasma generators, and more particularly to devices having a nozzle that discharges a plasma plume.

2. Discussion of the Related Art

In recent years, the progress on producing plasma by use of microwave energy has been increasing. Typically, a plasma producing system includes a device for generating microwave energy and a nozzle that receives the microwave energy to excite gas flowing through the nozzle into plasma. One of the difficulties in operating a conventional plasma producing system is providing an optimum condition for plasma ignition—a transition from the gas into the plasma. Several parameters, such as gas pressure, gas composition, nozzle geometry, material properties of nozzle components, intensity of microwave energy applied to the nozzle, and distance between the nozzle exit and the point in the nozzle where the microwave energy is focused, for instance, may affect the plasma ignition condition. The threshold intensity of the microwave energy for plasma ignition can be controlled if the point where the microwave energy is focused can be moved relative to the nozzle exit. Thus, there is a need for a nozzle that has a system for moving the point relative to the nozzle exit.

### SUMMARY OF THE INVENTION

According to one aspect of the present invention, a plasma generating system includes at least one nozzle. The nozzle includes: a housing having a cavity formed therein, where the cavity forms a gas flow passageway; a rod-shaped conductor disposed in the cavity and operative to transmit microwave energy along a surface thereof so that the microwave energy excites gas flowing through the cavity; and means for moving a proximal end of the rod-shaped conductor relative to a downstream end of the gas flow passageway.

The above, and other objects, features and advantages of the present invention will become apparent from the following description read in conjunction with the accompanying drawings, in which like reference numerals designate the same elements. The present invention is considered to include all functional combinations of the above described features and is not limited to the particular structural embodiments shown in the figures as examples. The scope and spirit of the present invention is considered to include modifications as may be made by those skilled in the art having the benefit of the present disclosure which substitute, for elements or processes presented in the claims, devices or structures or processes upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself. Still further it is understood that recitation of the preface of “a” or “an” before an element of a claim does not limit the claim to a singular presence of the element and the recitation may include a plurality of the element unless the claim is expressly limited otherwise. Yet further it will be understood that recitations in the claims which do not include “means for” or “steps for” language are not to be considered limited to equivalents of specific embodiments described herein.

### BRIEF DESCRIPTION OF THE DRAWINGS

FIG. 1 shows a schematic diagram of a plasma generating system in accordance with one embodiment of the present invention.

FIG. 2 shows an exploded view of a portion of the plasma generating system of FIG. 1.

FIG. 3 shows a side cross-sectional view of the portion of the plasma generating system of FIG. 2, taken along the line III-III.

FIG. 4 shows a schematic diagram of a plasma generating system in accordance with another embodiment of the present invention.

FIG. 5 shows a schematic diagram of a plasma generating system in accordance with yet another embodiment of the present invention.

FIG. 6 shows an exploded view of a portion of a plasma generating system in accordance with still another embodiment of the present invention.

FIG. 7 shows a schematic diagram of a plasma generating system in accordance with further another embodiment of the present invention.

FIG. 8 shows a perspective view of a portion of the plasma generating system of FIG. 7.

FIG. 9 shows a perspective view of a portion of a plasma generating system in accordance with further yet another embodiment of the present invention.

FIG. 10 shows a side cross sectional view of a portion of a plasma generating system in accordance with further still another embodiment of the present invention.

FIG. 11A shows a perspective view of a nozzle secured to a waveguide in accordance with another embodiment of the present invention.

FIG. 11B shows a side cross sectional view of the nozzle of FIG. 11A, taken along the line 11B-11B.

### DETAILED DESCRIPTION OF THE PREFERRED EMBODIMENTS

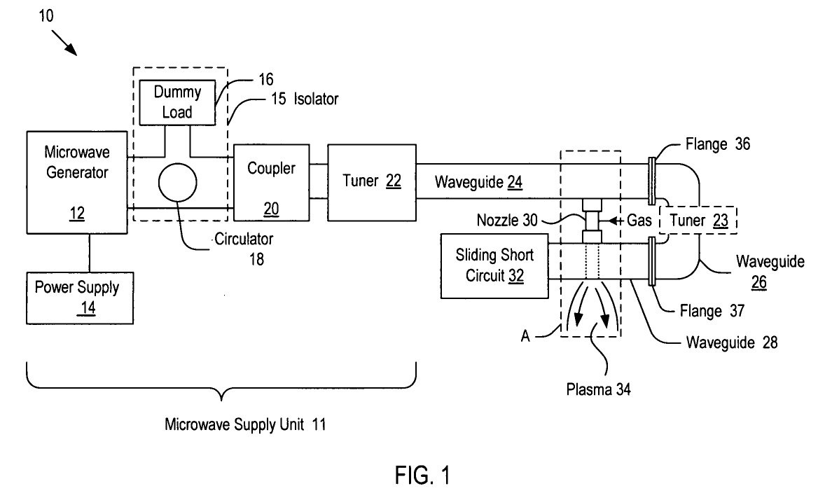

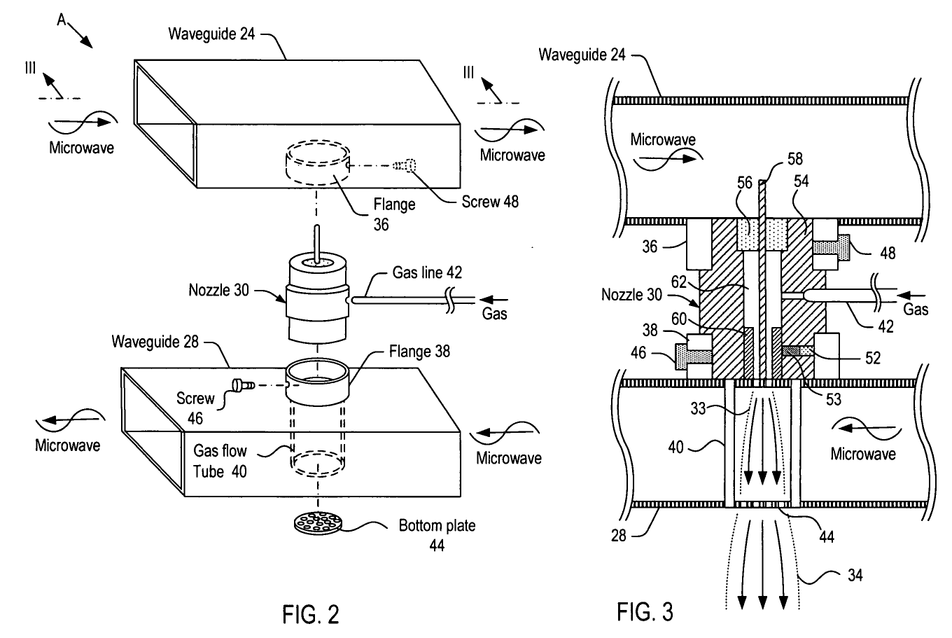

FIG. 1 shows a schematic diagram of a plasma generating system 10 in accordance with one embodiment of the present invention. A microwave supply unit 11 is interconnected with a nozzle 30 by a microwave supply structure which includes various embodiments to be described herein of which FIG. 1 shows one exemplary embodiment. As illustrated, the system 10 includes: a first (or primary) microwave cavity/waveguide 24; the microwave supply unit 11 for providing microwave energy to the first microwave waveguide 24; the nozzle 30 connected to the first microwave waveguide 24 and operative to receive microwave energy from the first microwave waveguide 24 and excite gas by use of the received microwave energy; a second waveguide 26 coupled to the first waveguide 24 by a flange 36; a third waveguide 28 coupled to the second waveguide 26 by a flange 37; and a sliding short circuit 32 disposed at the end of the third waveguide 28. As described in more detail below in conjunction with FIGS. 2 and 3, the gas excited by the nozzle 30 is excited again as the gas passes through a gas flow tube in the third waveguide 28 and exits the system in the form of plasma 34.

The microwave supply unit 11 provides microwave energy to the first microwave waveguide 24 and includes: a microwave generator 12 for generating microwaves; a power supply 14 for supplying power to the microwave generator 12; and an isolator 15 having a dummy load 16 for dissipating reflected microwave energy that propagates toward the microwave generator 12 and a circulator 18 for directing the reflected microwave energy to the dummy load 16.

The microwave supply unit 11 may further include a coupler 20 for measuring fluxes of the microwave energy; and a tuner 22 for reducing the microwave energy reflected from the sliding short circuit 32. The components of the microwave supply unit 11 shown in FIG. 1 are well known and are listed herein for exemplary purposes only. Also, it is possible to replace the microwave supply unit 11 with any other suitable system having the capability to provide microwave energy to the microwave waveguide 24 without deviating from the present invention. Likewise, the sliding short circuit 32 may be replaced by a phase shifter that can be configured in the microwave supply unit 11. Typically, a phase shifter is mounted between the isolator 15 and the coupler 20. An additional tuner 23 may be optionally disposed in the second waveguide 26.

FIG. 2 shows an exploded view of a portion A of the plasma generating system 10 of FIG. 1. FIG. 3 shows a side cross sectional view of the portion A of the plasma generating system 10, taken along the line III-III. As depicted, a ring-shaped flange 36 is affixed to the bottom surface of the first microwave waveguide 24 and the nozzle 30 is secured to the ring-shaped flange 36 by one or more suitable fasteners 48, such as screws. Another ring-shaped flange 38 is affixed to the top surface of the third waveguide 28 and the nozzle 30 is also secured to the ring-shaped flange 38 by one or more suitable fasteners 46, such as screws. A gas flow tube 40, which is formed of material transparent to the microwave, such as quartz, extends through the third waveguide 28.

The nozzle 30 includes a rod-shaped conductor 58; a housing or shield 54 formed of conducting material, such as metal, and having a generally cylindrical cavity therein so that the cavity forms a gas flow passageway 62; an electrical insulator 56 disposed in the cavity and adapted to hold the rod-shaped conductor 58 relative to the shield 54; a dielectric tube 60 disposed in the cavity; a spacer 53; and a fastener 52, such as a metal screw, for pushing the spacer 53 against the dielectric tube 60 to thereby secure the dielectric tube 60 to the shield 54. The spacer 53 is formed of dielectric material, such as Teflon®, and functions as a buffer for firmly pushing the dielectric tube 60 against the shield 54 without cracking the dielectric tube 60.

A top portion of the rod-shaped conductor 58 protrudes into the first microwave waveguide 24 and operates as an antenna to capture a portion of the microwave energy in the first waveguide 24. The captured microwave energy flows through the rod-shaped conductor 58. The gas supplied via a gas line 42 is injected into the cavity and excited by the microwave energy flowing through the rod-shaped conductor 58. The gas 33 exiting the nozzle 30 may be neutral or in the form of plasma. The inlet of the gas flow tube 40 is located at the downstream end of the gas flow passageway 62 defined by the cavity. The gas 33 flows through the gas flow tube 40 to be excited again by the microwave energy in the third waveguide 28 so that the gas 34 exiting through the holes formed in the bottom plate 44 is in the form of plasma.

The rod-shaped conductor 58, the dielectric tube 60, and the electric insulator 56 have functions similar to those of their counterparts of a nozzle described in U.S. Pat. No. 7,164,095, which is herein incorporated by reference in its entirety. For brevity, these components are not described in detail in the present document.

It is noted that the gas flowing through the nozzle 30 and the gas flow tube 40 are excited by the microwave energy flowing through the first and third waveguides 24, 28, respectively, while the microwave energy in those waveguides is provided by one microwave supply unit 11. As such, the nozzle system, which collectively refers to the nozzle 30 and the gas flow tube 40, has an enhanced mechanism to excite the gas without increasing the power consumed by the microwave supply unit 11.

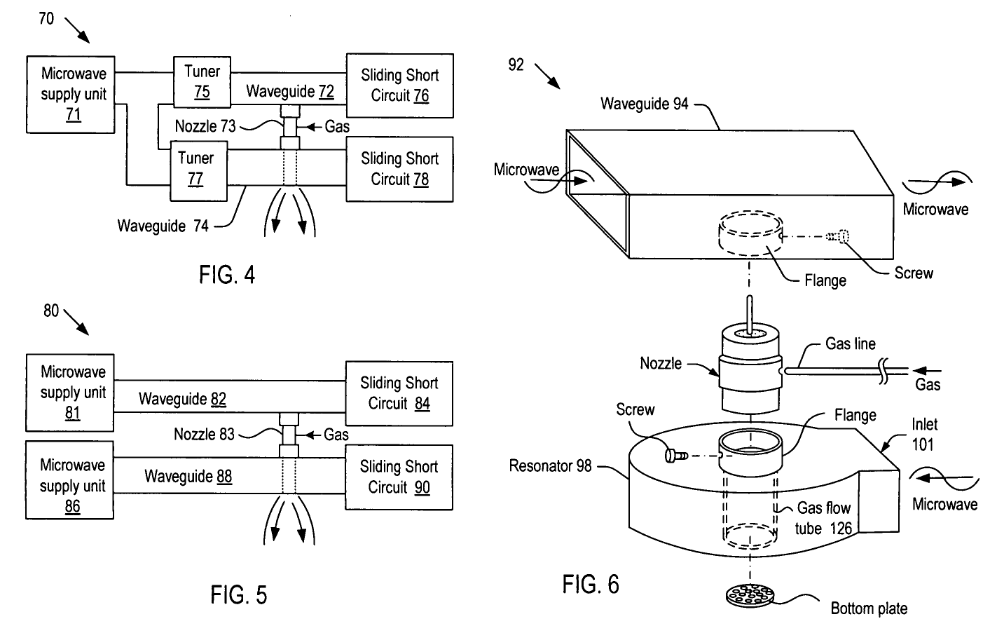

FIG. 4 shows a schematic diagram of a plasma generating system 70 in accordance with another embodiment of the present invention. As depicted, the system 70 is similar to the system 10, with the differences that a waveguide extending from the microwave supply unit 71 is branched into two waveguides 72, 74 and two sliding short circuits 76, 78 are respectively attached to the ends of the waveguides 72, 74. A nozzle 73 is interposed between the two waveguides 72, 74. Optionally, two tuners 75 and 77 may be disposed in the waveguides 72, 74.

FIG. 5 shows a schematic diagram of a plasma generating system 80 in accordance with yet another embodiment of the present invention. As depicted, the system 80 is similar to the system 10, with the differences that two waveguides 82, 88 are respectively coupled to two separate microwave supply units 81, 86 and two sliding short circuits 84, 90 are respectively attached to the ends of the waveguides 82, 88. A nozzle 83 is interposed between the two waveguides 82 and 88.

FIG. 6 shows an exploded view of a portion of a plasma generating system 92 in accordance with still another embodiment of the present invention. The plasma generating system 92 is similar to the system 10, with the difference that the third waveguide 28 of the system 10 is replaced by a resonator 98 having a generally cylindrical shape. The resonator 98 has an inlet 101 through which the microwave energy exiting the waveguide 94 flows. It is noted that the resonator 98 may be also used in the systems 70 and 80. For example, the resonator 98 may be used in place of the waveguide 74 and the sliding short circuit 78 of the system 70. In another example, the resonator 98 may be attached to the waveguide 88 of the system 80 and the sliding short circuit 90 may be omitted.

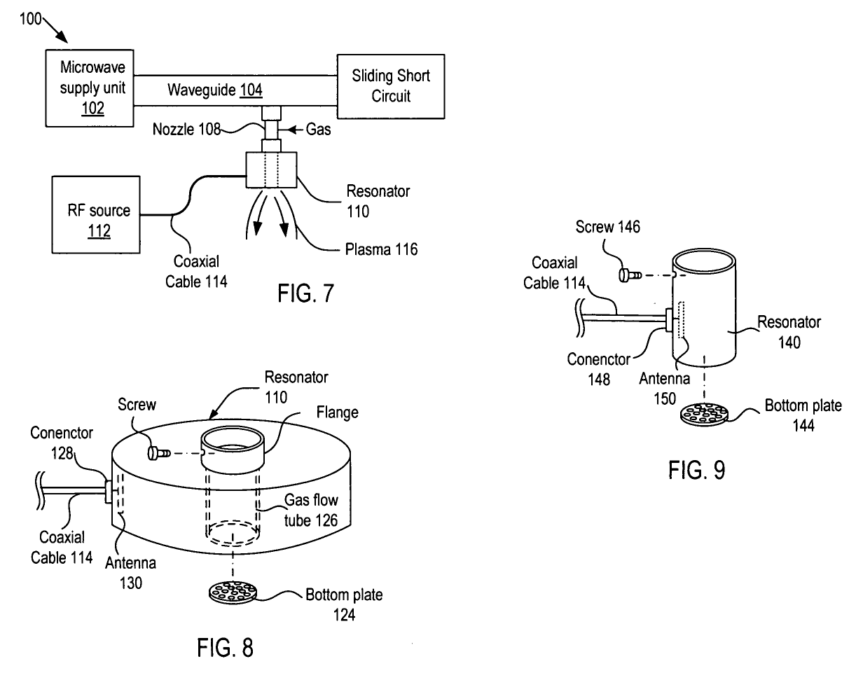

It is noted that the type of excitation energy for exciting the gas flowing through the gas flow tubes, such as 40, in FIGS. 1-6 is microwave energy. Depending on the type of gas flowing through the gas flow tubes, different types of excitation energy, such as RF energy, can be provided in resonators/chambers in which the gas flow tubes are disposed. (Hereinafter, the term chamber refers to a waveguide, a resonator, or any other suitable container housing a gas flow tube, such as 40, 126, and containing excitation energy.) FIG. 7 shows a schematic diagram of a plasma generating system 100 in accordance with further another embodiment of the present invention. FIG. 8 shows a perspective view of a portion of the plasma generating system 100 of FIG. 7. As depicted, a nozzle 108 having the same structure as the nozzle 30 is secured to the waveguide 104 and receives microwave energy transmitted from the microwave supply unit 102 via the waveguide 104. The nozzle 108 is also secured to a resonator 110 by one or more fasteners so that the gas exiting the nozzle 108 passes through a gas flow tube 126 disposed in the resonator 110. RF energy generated by an RF source 112 is transmitted through a coaxial cable 114 to the resonator 110. More specifically, one end of the coaxial cable 114 is coupled to an antenna 130 disposed in the resonator 110 via an RF connector 128. The antenna 130 may have the shape of a plate or a spiral coil. The gas flow tube 126 is formed of material transparent to RF energy.

The gas is excited by the microwave energy in the nozzle 108 such that the gas is in the form of plasma when flowing through the gas flow tube 126. The operational frequency of the RF source 112 may be selected depending on the type and degree of ionization of the plasma flowing through the gas flow tube 126 so that the excitation of the plasma is optimized. The excited plasma exits the resonator 110 via the holes formed in a bottom plate 124.

FIG. 9 shows a perspective view of a portion of a plasma generating system in accordance with another embodiment of the present invention. As depicted, the resonator 140 may be of the type that might be used in place of the resonator 110 of FIGS. 7 and 8. For simplicity, the nozzle 108 to be secured to the resonator 140 by a screw 146 is not shown in FIG. 9. The resonator 140 has the shape of a generally cylindrical shell, where the inner diameter of the resonator is dimensioned to accommodate the nozzle 108. An antenna 150 disposed inside the resonator 140 is coupled to the coaxial cable 114 via a connector 148 secured to the resonator 140. The resonator 140 functions as not only a cavity for containing RF energy therein but also a gas flow tube through which the gas exiting the nozzle 108 flows. The gas, preferably in the form of plasma, exits the resonator 140 through the holes formed in the bottom plate 144.

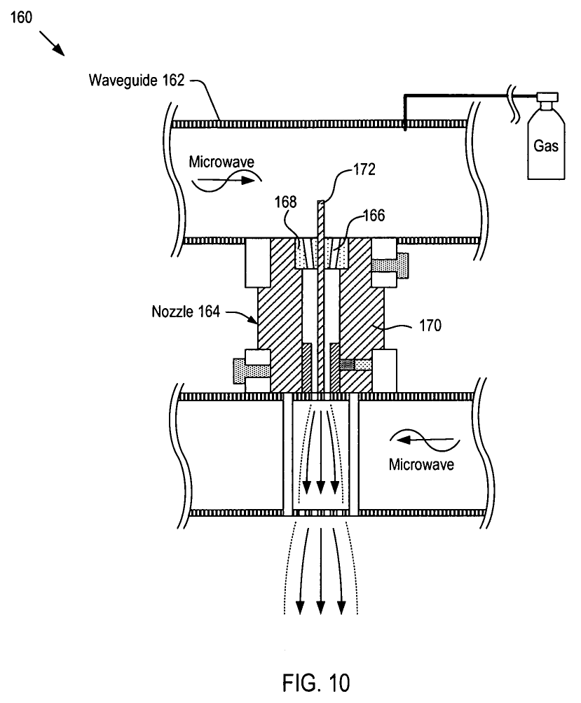

FIG. 10 shows a side cross-sectional view of a portion of a plasma generating system 160 in accordance with another embodiment of the present invention. As depicted, the system 160 is similar to the system 10 of FIG. 3, with the following difference in the gas injection system. The gas is supplied through a waveguide 162 and through holes 166 formed in an electric insulator 168, and in contrast to prior embodiments, a housing/insulator 170 of a nozzle 164 does not have a gas injection hole. The through holes 166 may be angled relative to a longitudinal axis of a rod-shaped conductor 172 to impart a helical shaped flow direction around the rod-shaped conductor 172 to a gas passing along the through holes 166.

The present invention includes the application of the gas injection system depicted in FIG. 10 to the embodiments described in FIGS. 1-9. It is also noted that the plasma generating systems depicted in FIGS. 1-10 have only one nozzle. However, it should be apparent to those of ordinary skill in the art that more than one nozzle can be used in each system. Detailed descriptions of systems having multiple nozzles and methods for operating the systems can be found in U.S. Pat. No. 7,164,095 and U.S. Patent Publication Serial Nos. 2006/0021581, 2006/0021980, 2008/0017616 and 2008/0073202, which are herein incorporated by reference in their entirety.

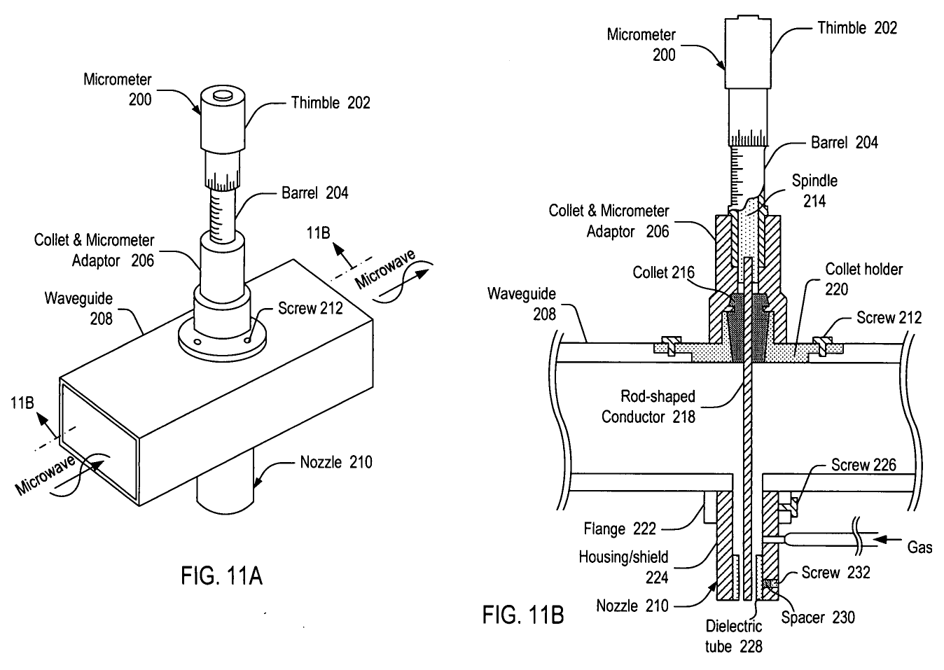

FIG. 11A shows a perspective view of a nozzle 210 secured to a waveguide 208 in accordance with another embodiment of the present invention. FIG. 11B shows a side cross-sectional view of the nozzle 210, taken along the line 11B-11B. As depicted, the nozzle 210 is secured to a ring-shaped flange 222 of the waveguide 208 by one or more fasteners 226 and includes: a rod-shaped conductor 218; a housing/shield 224; a dielectric tube 228 secured to the housing 224 by use of a spacer 230 and a fastener, such as screw, 232; and a micrometer 200.

The lower tip (or, equivalently, the proximal end) of the rod-shaped conductor 218 can be moved relative to the nozzle exit (or, equivalently, the downstream end of the cavity formed in the nozzle) in the vertical direction by the micrometer 200. The micrometer 200 includes a thimble 202 to be rotated by a user relative to the barrel 204. A spindle 214 is disposed inside the barrel 204 and moves in the vertical direction as the user rotates the thimble 202. The upper tip portion (or, equivalently, the distal end portion) of the rod-shaped conductor 218 is secured to the spindle 214. The barrel 204 is secured to a collet & micrometer adaptor 206 that is in turn secured to a collet 216, such as ER16 collet manufactured by DeAlmond Tool at Amarillo, Tex. A collet holder 220 accepts the collet 216, where one or more fasteners, such as screws, 212 are used to secure the collet holder 220 to the waveguide 208. The micrometer 200 and the collet 216 are commercially available. As such, detailed description of these components is not given in the present document.

Typically, the electrical impedance between the housing 224 and the rod-shaped conductor 218 is affected by the plasma generated at the nozzle exit such that, upon ignition of a plasma at the nozzle exit, the optimum operational impedance matching therebetween can be obtained by adjusting the distance between the lower tip of the rod-shaped conductor 218 and the nozzle exit. A user may rotate the thimble 202 to find the optimum locations of the lower tip of the rod-shaped conductor 218 relative to the nozzle exit for ignition and for efficient operation after ignition. The micrometer 200 may be replaced by any other suitable displacement device that is capable of moving the rod-shaped conductor 218 in the vertical direction.

During operation, plasma may be generated at the proximal end of the rod-shaped conductor 218. Alternatively, the present invention further includes the nozzle 210 used in place of the nozzles shown in FIGS. 1-10. For instance, the nozzle 210 may be secured to another ring-shaped flange, such as the flange 38 shown in FIG. 2, and an inlet portion of a gas flow tube disposed at the downstream end of the cavity of the nozzle 210, such as the gas flow tube 40 shown in FIG. 2.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims. Such modifications include substitution of components for components specifically identified herein, wherein the substitute component provides functional results which permit the overall functional operation of the present invention to be maintained. Such substitutions are intended to encompass presently known components and components yet to be developed which are accepted as replacements for components identified herein and which produce results compatible with operation of the present invention. For example, a microwave supply structure is shown which utilizes waveguide components, however, future developed substitutes for such components are considered to be within the scope of the claims for a microwave supply structure. Likewise, a displacement device is considered to include both known and future developed devices suffice the devices function to move structure as disclosed herein. Furthermore, while examples have been provided illustrating operation at certain frequencies, the present invention as defined in this disclosure and claims appended hereto is not considered limited to frequencies recited herein. Furthermore, the signals used in this invention are considered to encompass any electromagnetic wave transmission.

What is claimed is:

1. A plasma generating system, comprising:
at least one nozzle including:
a housing having a cavity formed therein, said cavity forming a gas flow passageway;
a rod-shaped conductor disposed in the cavity and operative to transmit microwave energy along a surface thereof so that the microwave energy excites gas flowing through the cavity; and
a displacement device configured to move a proximal end of the rod-shaped conductor relative to a downstream end of the gas flow passageway.

2. A plasma generating system as recited in claim 1, further comprising:
a microwave supply structure having a first waveguide having first and second surfaces; and
the housing being secured to the first surface of the first waveguide, the rod-shaped conductor extending through the first waveguide, the displacement device being disposed at second surface of the first waveguide opposite the first surface such that a portion of the rod-shaped conductor in the first waveguide picks up a portion of microwave energy traveling through the first waveguide.

3. A plasma generating system as recited in claim 2, further comprising:
a chamber for containing excitation energy; and
a gas flow tube disposed in the chamber and having an inlet disposed at the downstream end of the gas flow passageway such that the gas exiting the cavity through the downstream end flows through the gas flow tube and is excited by the excitation energy.

4. A plasma generating system as recited in claim 3, wherein the chamber is a second waveguide having an inlet connected to an outlet of the first waveguide and wherein the nozzle is secured to the chamber.

5. A plasma generating system as recited in claim 3, wherein the first waveguide is coupled to a first microwave supply unit, and the chamber is a second waveguide coupled to a second microwave supply unit.

6. A plasma generating system as recited in claim 3, wherein the chamber is a second waveguide branched off of the first waveguide.

7. A plasma generating system as recited in claim 3, wherein the chamber is a substantially cylindrical shell and includes a microwave energy inlet connected to an outlet of the first waveguide.

8. A plasma generating system as recited in claim 3, wherein the chamber is a substantially cylindrical shell and adapted to contain RF energy therein.

9. A plasma generating system as recited in claim 8, wherein an antenna for providing the RF energy into the chamber is disposed in the chamber.

10. A plasma generating system as recited in claim 8, wherein a wall of the chamber forms the gas flow tube.

11. A plasma generating system as recited in claim 3, wherein the displacement device includes a micrometer having a spindle, a distal end portion of the rod-shaped conductor has a distal end portion connected to the spindle of the micrometer.

12. A plasma generating system as recited in claim 2, wherein the displacement device includes a micrometer having a spindle, a distal end portion of the rod-shaped conductor has a distal end portion connect to the spindle of the micrometer.

13. A plasma generating system as recited in claim 2, wherein the first waveguide includes a communication structure for communicating gas into said housing via holes connecting an interior of the waveguide with the gas flow passageway.

14. A plasma generating system as recited in claim 1, wherein the displacement device includes a micrometer having a spindle, a distal end portion of the rod-shaped conductor has a distal end portion connect to the spindle of the micrometer.

15. A plasma generating system as recited in claim 1, further comprising:
a chamber for containing excitation energy; and
a gas flow tube disposed in the chamber and having an inlet disposed at the downstream end of the gas flow passageway, such that the gas exiting the cavity through the downstream end flows through the gas flow tube and is excited by the excitation energy.

16. A plasma generating system as recited in claim 15, wherein the chamber is a waveguide coupled to a microwave source.

17. A plasma generating system as recited in claim 15, wherein the housing includes a gas inlet hole.

18. A plasma generating system as recited in claim 15, wherein the displacement device includes a micrometer having a spindle, a distal end portion of the rod-shaped conductor has a distal end portion connected to the spindle of the micrometer.

19. A plasma generating system as recited in claim 1, wherein the housing includes a gas inlet hole.
